(19) United States
(12) Patent Application Publication
(10) Pub. No.: US 2021/0245647 A1
(43) Pub. Date: Aug. 12, 2021

(54) ROBOT AND CONTROL METHOD

(71) Applicant: SONY CORPORATION, TOKYO (JP)

(72) Inventors: TAKASHI KITO, TOKYO (JP); YUKI ITOTANI, TOKYO (JP); KOJI NAKANISHI, KANAGAWA (JP); TAKARA KASAI, TOKYO (JP); KAZUO HONGO, TOKYO (JP); YASUHISA KAMIKAWA, TOKYO (JP); ATSUSHI SAKAMOTO, TOKYO (JP)

(21) Appl. No.: 17/253,879

(22) PCT Filed: Jun. 19, 2019
(86) PCT No.: PCT/JP2019/024385

§ 371 Date: Dec. 18, 2020

(30) Foreign Application Priority Data
Jun. 26, 2018 (JP) 2018-121050

(51) Int. Cl. B60P 1/02

(52) U.S. Cl. CPC B60P 1/025

(57) ABSTRACT

A robot (1) includes: a main body (10) including a hollow portion (110) that is a hollow space penetrating the main body (10) in an up-down direction, the main body (10) being configured to lift and support a support object (30) inserted in the hollow portion (110) by moving in the up-down direction; and a movable member (200) configured to move the main body (10) at least in the up-down direction by operating a leg (20).

### FIELD

The present disclosure relates to a robot and a control method.

### BACKGROUND

A typical load carrying robot carries a load by performing a series of operations including loading the load on a platform, moving to a carrying destination, and unloading the load from the platform. The loading and unloading of the load are performed by using an arm of the load carrying robot or an arm device installed outside the robot, or the like. The moving to the carrying destination is performed by using a moving mechanism such as a leg. In this manner, the typical load carrying robot includes separate mechanisms according to operations. Thus, the load carrying robot requires a space for the arm device to operate during the loading and unloading of the load and a space for the load carrying robot to move during the carrying of the load to perform the above operations. However, when a sufficient operation space for the load carrying robot cannot be secured, it is difficult for the load carrying robot to carry the load. Thus, the load carrying robot desirably has a simpler configuration and a smaller size to enable the load carrying robot to perform operations in a smaller operation space.

For example, Patent Literature 1 discloses a leg type mobile robot that loads a carrying object on a body and unloads the carrying object from the body by using legs and also moves to a carrying destination by using the legs. The leg type mobile robot includes the legs serving as both an arm mechanism and a moving mechanism and thus has a simpler configuration than the typical load carrying robot.

### CITATION LIST

### Patent Literature

Patent Literature 1: JP 2016-020103 A

### SUMMARY

### Technical Problem

However, the legs of the leg type mobile robot are disposed outside the leg type mobile robot. In addition, motions in loading and unloading of the load are similar to those of the typical load carrying robot. Thus, reduction in a space required of the leg type mobile robot for its operation is not expected much.

Thus, the present disclosure provides a robot and a control method that are new and improved, and enable downsizing of a load carrying robot and reduction in an operation space.

### Solution to Problem

According to the present disclosure, a robot is provided that includes: a main body including a hollow portion that is a hollow space penetrating the main body in an up-down direction, the main body being configured to lift and support a support object inserted in the hollow portion by moving in the up-down direction; and a movable member configured to move the main body at least in the up-down direction by operating a leg.

Moreover, according to the present disclosure, a control method executed by a processor is provided that includes: controlling at least motions in an upward direction and a downward direction of a control object including a hollow portion that is a hollow space on a basis of support object information related to a support object; and controlling a supporting motion of the control object with respect to the support object inserted in the hollow portion.

### Advantageous Effects of Invention

As described above, the present disclosure provides a robot and a control method that are new and improved, and enable downsizing of a load carrying robot and reduction in an operation space. Note that the effects of the present disclosure are not necessarily limited to the above effects. The present disclosure may achieve, in addition to or instead of the above effects, any effect described in the specification or another effect that can be grasped from the specification.

### BRIEF DESCRIPTION OF DRAWINGS

FIG. 1 is a schematic view of the appearance of a robot according to an embodiment of the present disclosure viewed from above.

FIG. 2 is a schematic view of the appearance of the robot according to the embodiment viewed from the right side.

FIG. 3 is a sectional view of a main body according to the embodiment taken in a longitudinal direction.

FIG. 4 is a sectional view of the main body according to the embodiment taken in a lateral direction.

FIG. 5 is a diagram illustrating an example of insertion of a support object into a hollow portion according to the embodiment.

FIG. 6 is a diagram illustrating an example of the position of the center of gravity of the supported support object according to the embodiment.

FIG. 7 is a diagram illustrating an example of support of the support object by the support member according to the embodiment.

FIG. 8 is a diagram illustrating an external configuration example of a leg according to the embodiment.

FIG. 9 is a diagram illustrating, in outline, an axial configuration of the leg according to the embodiment viewed from above.

FIG. 10 is a block diagram illustrating a functional configuration example of the main body according to the embodiment.

FIG. 11 is a diagram illustrating an example of an attitude control process of the robot according to the embodiment.

FIG. 12 is a diagram illustrating the flow of a support start motion of the robot according to the embodiment.

FIG. 13 is a flowchart illustrating the flow of a support start motion process in a control unit according to the embodiment.

FIG. 14 is a diagram illustrating the flow of a support finish motion of the robot according to the embodiment.

FIG. 15 is a flowchart illustrating the flow of a support finish motion process in the control unit according to the embodiment.

FIG. 16 is a diagram illustrating an example of a method for detecting the support object according to the embodiment.

FIG. 17 is a diagram illustrating an example of an attitude control process using communication according to the embodiment.

FIG. 18 is a diagram illustrating an example of an attitude control process using a distance measuring sensor according to the embodiment.

FIG. 19 is a diagram illustrating an example of an attitude control process using a laser light source according to the embodiment.

FIG. 20 is a diagram illustrating an example of correction of a tilt of the support object caused by a projection according to the embodiment.

FIG. 21 is a diagram illustrating an example of correction of a tilt of the support object caused by a recess according to the embodiment.

FIG. 22 is a diagram illustrating a modification of the embodiment.

FIG. 23 is a block diagram illustrating a hardware configuration example of a robot according to an embodiment.

### DESCRIPTION OF EMBODIMENTS

Hereinbelow, a preferred embodiment of the present disclosure will be described in detail with reference to the accompanying drawings. Note that, in the specification and drawings, elements having substantially the same functional configuration are designated by the same reference sign to omit redundant description.

Note that the description will be made in the following order.

1. Embodiment of the Present Disclosure

1.1 Outline

1.2 External Configuration Example

1.3 Functional Configuration Example

1.4 Motion Example

2. Exemplary Embodiments

3. Modification

4. Hardware Configuration Example

5. Summary

### 1. Embodiment of the Present Disclosure

### 1.1. Outline

A typical load carrying robot carries a load by performing a series of operations including loading the load on a platform, moving to a carrying destination, and unloading the load from the platform. The loading and unloading of the load are performed by using an arm of the load carrying robot or an arm device installed outside the robot. The moving to the carrying destination is performed by using a moving mechanism such as a leg. In this manner, the typical load carrying robot includes separate mechanisms according to operations. Thus, the load carrying robot requires a space for the arm device to operate during the loading and unloading of the load and a space for the load carrying robot to move during the carrying of the load to perform the above operations. However, when a sufficient operation space for the load carrying robot cannot be secured, it is difficult for the load carrying robot to carry the load. Thus, the load carrying robot desirably has a simpler configuration and a smaller size to enable the load carrying robot to perform operations in a smaller operation space.

A robot according to an embodiment of the present disclosure has been created in view of the above circumstances as one point of view. The robot according to the embodiment includes a main body, a movable member, and a plurality of legs. The main body includes a hollow portion that is a hollow space penetrating the main body in an up-down direction. The movable member is driven to operate each of the legs. The main body is coupled to each of the legs. Thus, the main body moves at least in the up-down direction by operating each of the legs by driving the movable member. The main body is capable of inserting a support object (e.g., a load) into the hollow portion and lifting and supporting the inserted support object by moving in the up-down direction. Note that the motion in the up-down direction of the main body caused by driving the movable member and the supporting motion of the main body with respect to the support object are controlled on the basis of support object information related to the support object. The support object information can include, for example, information related to the position of the support object and information related to the attitude of the support object such as a tilt.

Moreover, the movable member may be implemented as the movable member alone or implemented as a joint member of the leg having the function of the movable member. The present embodiment describes an example in which the joint member has the function of the movable member. Moreover, a dedicated container having a shape supportable by a main body 10 is used as the support object according to the present embodiment.

This enables the robot according to the present embodiment to load and unload a load without using an arm device. Thus, the robot can be downsized by the elimination of the arm device. Moreover, the robot according to the present embodiment can load and unload the load only by motions in the up-down direction. Thus, the operation space can be reduced as compared to the case where the load is loaded and unloaded using the arm device. Hereinbelow, details of the present embodiment will be described in order.

### 1.2. External Configuration Example

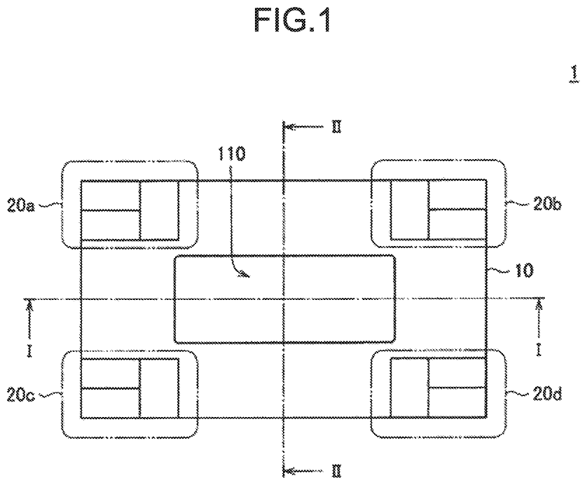

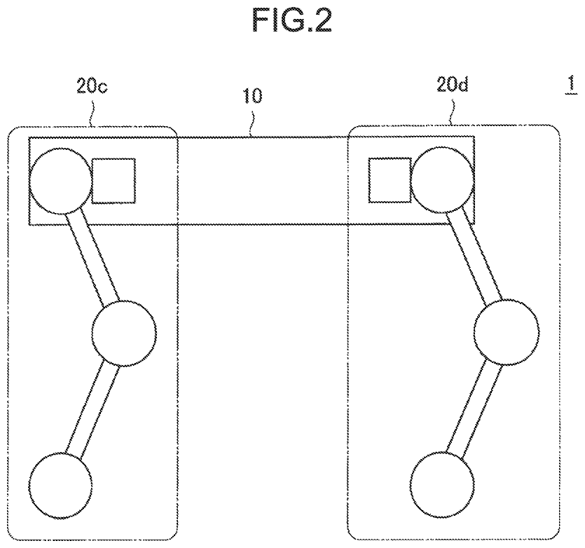

Hereinbelow, an external configuration example of a robot 1 according to the embodiment of the present disclosure will be described with reference to FIGS. 1 to 9. FIG. 1 is a schematic view of the appearance of the robot 1 according to the embodiment of the present disclosure viewed from above. FIG. 2 is a schematic view of the appearance of the robot 1 according to the embodiment of the present disclosure viewed from the right side. As illustrated in FIGS. 1 and 2, the robot 1 includes a main body 10 and four legs 20. The main body 10 includes a hollow portion 110, which is a hollow space penetrating the main body 10 in an up-down direction. The four legs 20 include a leg 20a, a leg 20b, a leg 20c, and a leg 20d. Each of the four legs 20 can be configured to be detachable from the main body 10.

The four legs 20 can all be of the same type. However, the present disclosure is not limited to this example, and the legs 20 that differ from each other in type, for example, in axial configuration may be used in combination. Moreover, the number of legs 20 is not limited to four. For example, the number of legs 20 may be two or six.

Note that, in the robot 1, with respect to line I-I, a side having the leg 20c and the leg 20d corresponds to the right side of the main body 10, and a side having the leg 20a and the leg 20b corresponds to the left side of the main body 10. Moreover, in the robot 1, with respect to line II-II, a side having the leg 20b and the leg 20d corresponds to the front side of the main body 10, and a side having the leg 20a and the leg 20c corresponds to the rear side of the main body 10.

### (1) Main Body 10

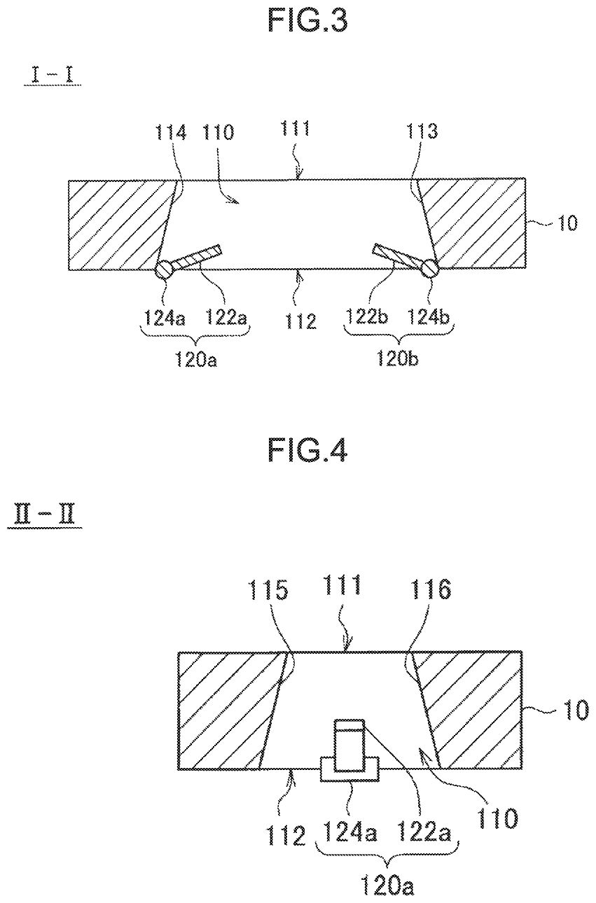

Hereinbelow, details of the main body 10 will be described with reference to FIGS. 3 and 4. FIG. 3 is a sectional view of the main body 10 according to the embodiment of the present disclosure taken in a longitudinal direction (sectional view taken along line I-I in FIG. 1). FIG. 4 is a sectional view of the main body 10 according to the embodiment of the present disclosure taken in a lateral direction (sectional view taken along line II-II in FIG. 1).

As illustrated in FIGS. 3 and 4, the main body 10 includes the hollow portion 110 and a support member 120. The main body 10 inserts a support object into the hollow portion 110 and supports the support object by using the support member 120. Specifically, the main body 10 inserts the support object into the hollow portion 110 by moving at least in a downward direction when the main body 10 is located above the support object. Then, the support member 120 supports the support object inserted in the hollow portion 110 by the main body 10. Then, the main body 10 lifts and supports the support object by moving at least in an upward direction when the support object is supported by the support member 120.

### (1-1) Hollow Portion 110

The hollow portion 110 is a hollow space penetrating the main body 10 in the up-down direction. For example, the hollow portion 110 is a space penetrating an upper face and a lower face of the main body 10. Specifically, the hollow portion 110 is a space penetrating the main body 10 between an opening 111 (first opening) on the upper face and an opening 112 (second opening) on the lower face.

(Shape of Hollow Portion 110)

The hollow portion 110 has, for example, a wedge shape. The difference between the area of the opening 111 and the area of the opening 112 forms the wedge shape. Specifically, the wedge shape is formed because the area of the opening 111 is smaller than the area of the opening 112 and tapered from the opening 112 toward the opening 111. The wedge shape of the hollow portion 110 produces inclination of a hollow portion front face 113, a hollow portion rear face 114, a hollow portion right side face 115, and a hollow portion left side face 116 inside the main body 10 (hereinbelow, also collectively referred to as a main body inner face). Hereinbelow, the inclination is also referred to as the inclination of the main body inner face. When the main body 10 inserts a support object 30 into the hollow portion 110, the main body 10 can smoothly perform the insertion of the support object 30 into the hollow portion 110 by using the inclination of the hollow portion 110. Note that the shape of the hollow portion is not limited to the wedge shape and may be any shape, but desirably the wedge shape for smooth insertion of the support object 30.

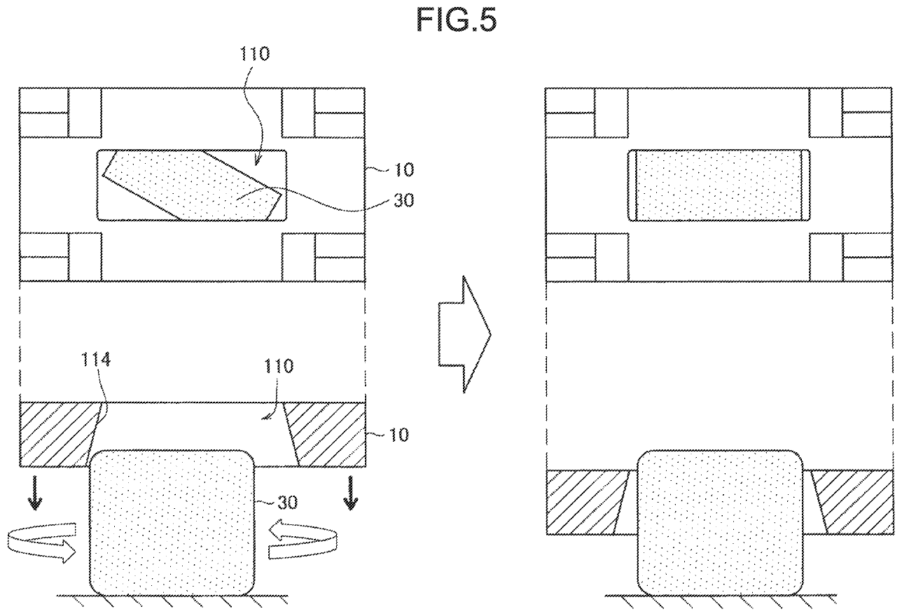

The smooth insertion of the support object into the hollow portion 110 will be described with reference to FIG. 5. FIG. 5 is a diagram illustrating an example of insertion of the support object 30 into the hollow portion 110 according to the embodiment of the present disclosure. The left figure in FIG. 5 illustrates the state of the support object 30 before insertion, and the right figure in FIG. 5 illustrates the state of the support object 30 after insertion. The left and right upper figures in FIG. 5 are top views of the robot 1, and the left and right lower figures in FIG. 5 are diagrams illustrating the state of the support object 30 at the position of a cross section taken along line I-I in FIG. 1.

The position and the orientation of the support object 30 are desirably a position and an orientation that enable the support object 30 to be fitted in the opening 111 without coming into contact with the main body inner face when the main body 10 moves in the downward direction. This is because, when the support object 30 comes into contact with the main body inner face, for example, the support object 30 may not be inserted up to the opening 111, and the main body 10 may not be able to support the support object. In this case, it is necessary for the main body 10 to perform the motion for inserting the support object 30 into the hollow portion 110 again, which is inefficient. Specifically, in a case where the position and the orientation of the support object 30 are the position and the orientation illustrated in the left figure in FIG. 5, when the main body 10 moves in the downward direction, the upper part of the support object 30 partially comes into contact with the hollow portion rear face 114. However, when the main body 10 continuously moves in the downward direction with the support object 30 kept in contact with the main body inner face, the support object 30 moves or rotates along the inclination of the main body inner face by being pressed against the inclination of the main body inner face. Then, as illustrated in the right figure in FIG. 5, the position and the orientation of the support object 30 are finally brought into the position and the orientation that enable the support object 30 to be fitted in the opening 111.

In the example described above, the position and the orientation of the support object 30 are the position and the orientation that bring the support object 30 into contact with the main body inner face. Note that at least the position or the orientation of the support object 30 may be the position or the direction that brings the support object 30 into contact with the main body inner face.

(Position of Center of Gravity of Hollow Portion 110)

The main body 10 can stably support and carry the support object 30 by supporting the support object 30 near the center of gravity of the main body 10. Thus, the hollow portion 110 is desirably disposed at a position that enables the main body 10 to support the support object 30 near the center of gravity of the main body 10. The robot 1 can reduce imbalance in joint torque and imbalance in toque in right and left and front and rear to improve the stability in the attitude of the robot 1 by supporting the support object 30 near the center of gravity of the main body 10.

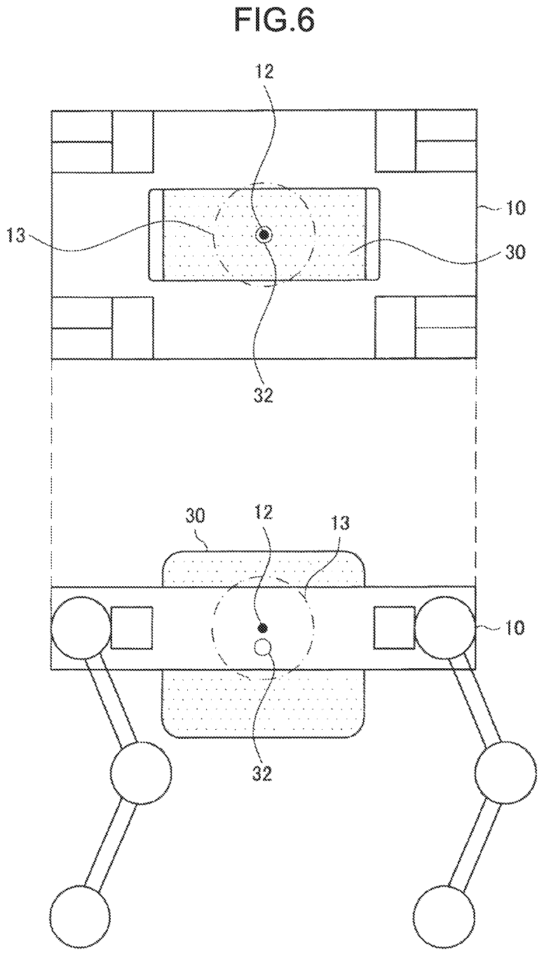

The position of the center of gravity of the hollow portion will be described with reference to FIG. 6. FIG. 6 is a diagram illustrating an example of the position of the center of gravity of the supported support object 30 according to the embodiment of the present disclosure. The upper figure in FIG. 6 is a top view of the robot 1. The lower figure in FIG. 6 is a right side view of the robot 1.

In the example illustrate in FIG. 6, a center of gravity 32 of the support object 30 supported by the robot 1 is located within a predetermined range 13 from the position of a center of gravity 12 of the main body 10. To position the center of gravity 32 of the support object 30 within the predetermined range 13 in this manner, the hollow portion 110 is preferably formed in such a manner that the center of gravity of the hollow portion 110 is also located within the predetermined range 13 from the position of the center of gravity 12 of the main body 10. In the example illustrated in FIG. 6, the hollow portion 110 is formed in such a manner that the position of the center of gravity (not illustrated) of the hollow portion 110 coincides with the position of the center of gravity 12 of the main body 10.

### (1-2) Support Member 120

The support member 120 has a function of supporting the support object 30. The support member 120 includes, for example, a claw 122 and a shaft 124 and supports the support object 30 by engaging the claw 122 with the support object 30. The claw 122 is connected to the shaft 124, which is movable, and moves along with the movement of the shaft 124. The claw 122 has, for example, a rectangular shape. The shaft 124 is disposed on the main body inner face. The shaft 124 includes, for example, an elastic body, such as a spring, and moves using the elastic force of the spring to move the claw 122, thereby engaging the claw 122 with the support object 30. When the claw 122 and the support object 30 are engaged with each other, the support member 120 may fix the claw 122 by using a latch mechanism to fixedly support the support object 30. In the present embodiment, as illustrated in FIG. 3, two support members 120a and 120b are respectively disposed on the hollow portion front face 113 and the hollow portion rear face 114. Note that the configuration, the number, the installation position of the support member 120 are not limited to the above example. For example, the support member 120 may be configured to attract the support object 30 by a magnetic force or air pressure to support the support object 30.

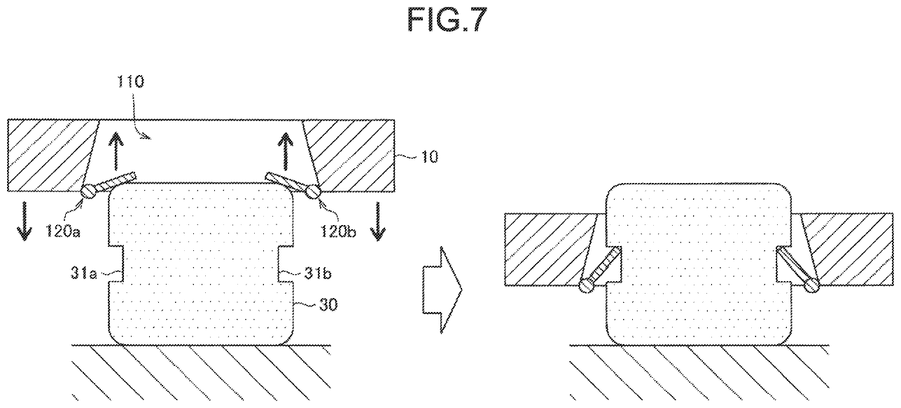

The support of the support object 30 by the support member 120 will be specifically described with reference to FIG. 7. FIG. 7 is a diagram illustrating an example of support of the support object 30 by the support member 120 according to the embodiment of the present disclosure. The left figure in FIG. 7 illustrates the state of the support member 120 before support. The right figure in FIG. 7 illustrates the state of the support member 120 after support.

The support member 120 inserts the claw 122 into a recess of the support object 30 by moving in the downward direction along with the downward movement of the main body 10, thereby engaging with the support object 30. As illustrated in FIG. 7, the main body 10 inserts the support object 30 into the hollow portion 110 by moving in the downward direction. The claw 122 of the support member 120 comes into contact with the support object 30 by the downward movement of the main body 10. When the main body 10 continuously moves in the downward direction after the claw 122 comes into contact with the support object, the claw 122 is pushed up by the support object 30. The claw 122 moves up to the position of a recess 31 of the support object 30 by the main body 10 further moving in the downward direction with the claw 122 pushed up. After moving to the position of the recess 31, the claw 122 is engaged with the recess 31 as illustrated in the right figure in FIG. 7. This enables the support member 120 to support the support object 30.

The support member 120 can have various configurations as a configuration that releases the engagement between the support member 120 and the support object 30 at the end of the support of the support object 30. For example, the support member 120 may include an actuator. The support member 120 may move the claw 122 by driving the actuator to release the engagement between the claw 122 and the recess 31.

Alternatively, the support member 120 may include a mechanism that releases the engagement between the support member 120 and the support object 30 by movement of the main body 10.

### (2) Leg 20

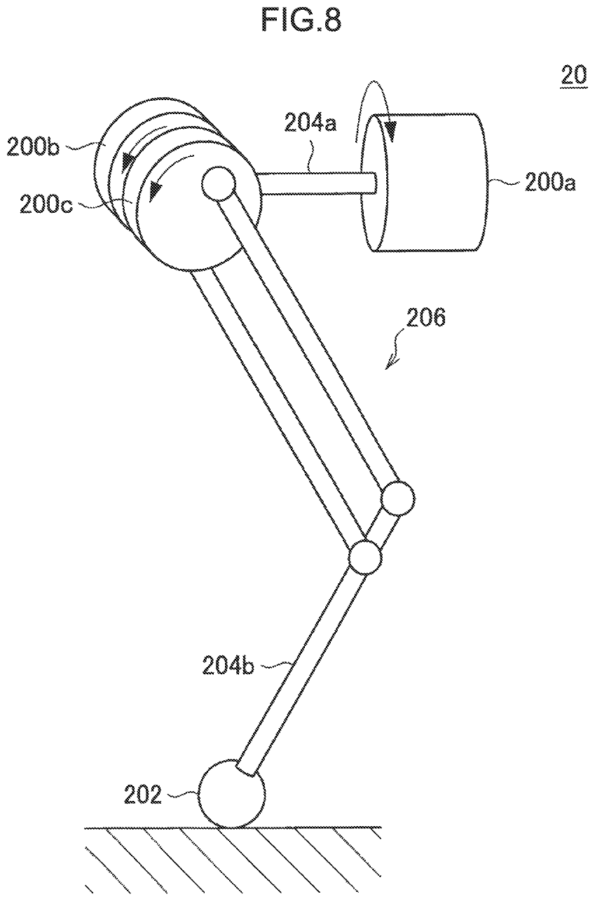

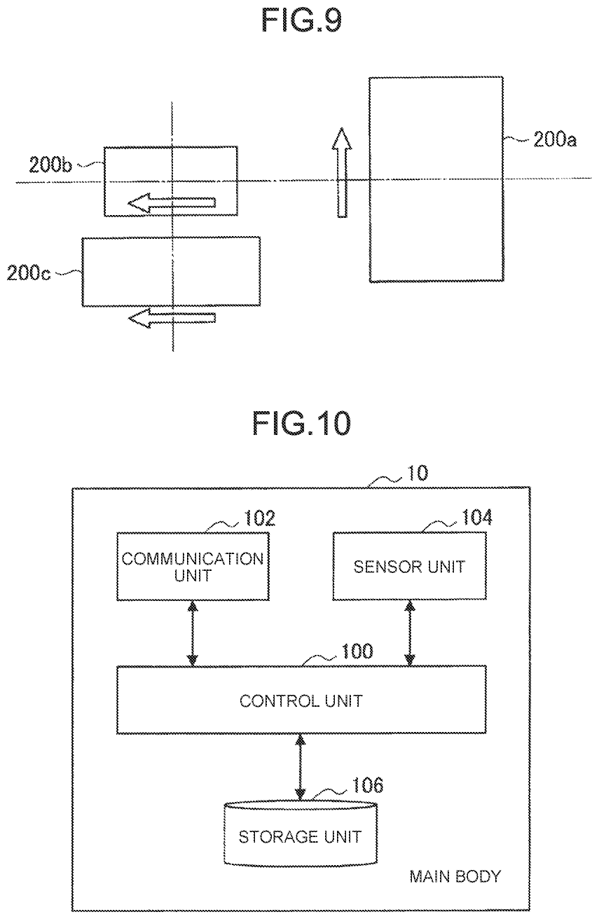

Hereinbelow, an external configuration example of the leg 20 according to the embodiment of the present disclosure will be described with reference to FIGS. 8 and 9. FIG. 8 is a diagram illustrating the external configuration example of the leg 20 according to the embodiment of the present disclosure. FIG. 9 is a diagram illustrating, in outline, an axial configuration of the leg 20 according to the embodiment of the present disclosure viewed from above.

As illustrate in FIG. 8, the leg 20 can be configured as, for example, a link mechanism including a plurality of joint members 200 (movable members) and a plurality of links 204. The leg 20 includes, as the plurality of joint members 200, a hip joint roll shaft 200a which rotates in a Roll axis direction, a hip joint Pitch shaft 200b which rotates in a Pitch axis direction, and a knee joint Pitch shaft 200c joint member 200 which rotates in the Pitch axis direction. Each of the joint members 200 includes an actuator inside thereof and rotates in the corresponding axis direction by driving the actuator. As illustrated in FIG. 9, the joint members 200 may be disposed in such a manner that a rotation axis of the hip joint Pitch shaft 200b coincides with a rotation axis of the knee joint Pitch shaft 200c.

The leg 20 includes a link 204a which couples the hip joint roll shaft 200a and the hip joint Pitch shaft 200b to each other. The leg 20 may include a closed link mechanism 206 which is coupled to the hip joint Pitch shaft 200b and the knee joint Pitch shaft 200c. Accordingly, a force output from the actuator that drives the hip joint Pitch shaft 200b can be transmitted to the knee joint Pitch shaft 200c.

The leg 20 further includes a toe 202 (tip portion). The toe 202 is disposed on a tip of a link 204b which is included in the closed link mechanism 206. The toe 202 is in contact with a travel road surface on which the robot 1 moves. The toe 202 is covered with, for example, an elastomer so that appropriate friction is generated between the toe 202 and the travel road surface. The toe 202 may be provided with a wheel. This enables the robot 1 to move on the travel road surface more smoothly and at high speed. Each of the legs 20 may be provided with a sensor for detecting, for example, a contact state between the toe 202 and the travel road surface and a contact state between the toe 202 and an object such as the support object 30.

The legs 20 configured as described above enable the robot 1 to move the position of the toe 202 of each of the legs 20 when viewed from a fixed position of the leg 20 with respect to the main body 10 (e.g., the position of the hip joint roll shaft 200a) in three directions: the longitudinal direction; the lateral direction; and the height direction. This enables the robot 1 (more specifically, the main body 10) to apply a force to any direction in the outside by changing the position and the attitude of each of the legs 20. Moreover, the main body 10 can change moment of the force produced by each of the legs 20 according to the magnitude of a frictional force generated when the leg 20 makes contact with another object. Moreover, since a toe trajectory of each of the legs 20 can be a three-dimensional free trajectory, the robot 1 can also climb over or avoid one or more obstacles.

The legs 20 perform a bending and stretching motion by operating the joint members 200 to move the main body 10 at least in the up-down direction by the bending and stretching motion. The robot 1 can lift and lower the support object 30 by moving the main body 10 in the up-down direction by causing the legs 20 to perform the bending and stretching motion with the support object 30 supported by the support member of the main body 10. Moreover, the robot 1 can carry the support object 30 by operating and moving the legs 20 with the support object 30 lifted and supported.

The configuration of the legs 20 is not limited to the configuration that moves the main body 10 in the up-down direction by the bending and stretching motion. For example, the configuration of the legs 20 may be a configuration that moves the main body 10 in the up-down direction by a linear motion.

Note that the axial configuration of each of the legs 20 according to the embodiment is not limited to the above example. For example, the number of axes of the leg 20 may be any number of one or more (e.g., one axis or ten axes). The link mechanisms included in the leg 20 may all be serial links, may all be parallel links, or may be a combination of one or more serial links and one or more parallel links. Moreover, the leg 20 may include one or more underactuated joints (that is, joints that are not driven by an actuator). Furthermore, the number of actuators included in the leg 20 (the number of actuators controllable by the leg 20) is also not limited to any particular number.

### 1.3. Functional Configuration Example

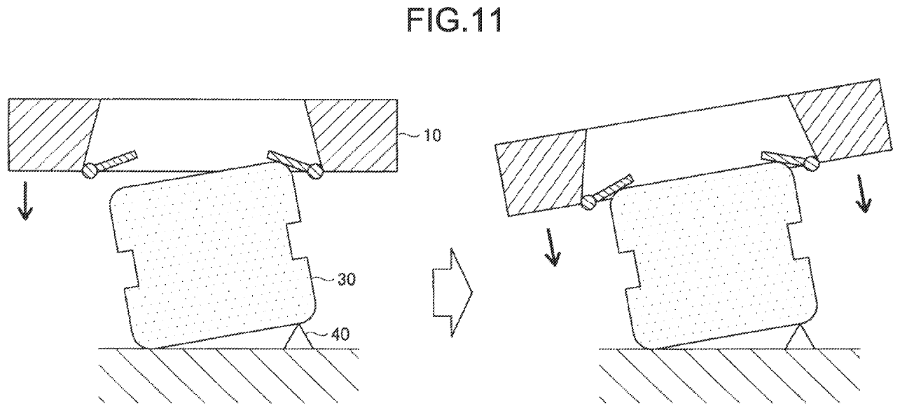

Hereinbelow, a functional configuration example of the main body 10 according to the embodiment of the present disclosure will be described with reference to FIGS. 10 and 11. FIG. 10 is a block diagram illustrating the functional configuration example of the main body 10 according to the embodiment of the present disclosure. As illustrated in FIG. 10, the robot 1 according to the embodiment of the present disclosure includes a control unit 100, a communication unit 102, a sensor unit 104, and a storage unit 106.

### (1) Control Unit 100

The control unit 100 has a function of controlling the motion of the robot 1. A process executed by the control unit 100 to control the motion of the robot 1 will be described in detail.

### (1-1) Detection Process

The control unit 100 performs a detection process based on acquired information. For example, the control unit 100 causes the communication unit 102 included in the main body 10 of the robot 1 to perform communication with a communication unit of the support object 30 to acquire support object information. Then, the control unit 100 detects the position of the support object 30 on the basis of the support object information acquired by the communication unit 102. The control unit 100 causes the sensor unit 104 included in the main body 10 of the robot 1 to sense the support object 30 to acquire support object information. Then, the control unit 100 detects the position of the support object 30 on the basis of the support object information acquired by the sensor unit 104. The control unit 100 detects a destination as a carrying destination of the support object 30 on the basis of the support object information acquired by the communication unit 102 or the sensor unit 104. Moreover, the control unit 100 detects the attitude of the robot 1 on the basis of the support object information acquired by the communication unit 102 or the sensor unit 104.

The support object information acquired by the above communication is, for example, positional information of the support object 30. The positional information may be previously registered in a storage device included in the support object 30, or the like, or may be sequentially acquired by the Grobal Positioning System (GPS) included in the support object 30. The information acquired by the above sensing is, for example, the distance from the robot 1 to the support object 30. The distance is detected by sensing performed by, for example, a camera included in the sensor unit 104 or a distance measuring device. The support object 30 may be provided with a QR code (registered trademark). The control unit 100 may read the QR code by using the camera of the sensor unit 104 to acquire support object information.

### (1-2) Determination Process

The control unit 100 performs a determination process based on the information detected in the detection process. For example, the control unit 100 determines, on the basis of the position of the support object 30 detected in the detection process, the position of the support object 30 to be an execution position of motions in the upward direction and the downward direction of the robot 1. Note that, hereinbelow, the upward motion of the robot 1 is also referred to as a standing-up motion, and the downward motion of the robot 1 is also referred to as a crouching motion. That is, the position of the support object 30 is a support start position where the robot 1 starts support of the support object 30. Moreover, the control unit 100 determines, on the basis of the destination detected in the detection process, the destination to be an execution position of motions in the upward direction and the downward direction of the robot 1. That is, the destination is a support finish position where the robot 1 finishes the support of the support object 30.

### (1-3) Motion Control Process

The control unit 100 performs a motion control process of the robot 1. The control unit 100 performs, for example, a process for moving the robot 1. Specifically, the control unit 100 moves the robot 1 to the execution position determined in the determination process.

The control unit 100 performs a process for causing the robot 1 to perform motions in the upward direction and the downward direction at the execution position. Specifically, when the robot 1 moves to the execution position, the control unit 100 causes the robot 1 to perform a motion in the downward direction. On the other hand, when the robot 1 starts or finishes the support of the support object 30 at the execution position, the control unit 100 causes the robot 1 to perform a motion in the upward direction.

The control unit 100 performs a process for controlling a supporting motion of the robot 1. For example, when the robot 1 performs a motion in the downward direction, the control unit 100 causes the support member 120 included in the robot 1 to start or finish support of the support object 30. Specifically, when the support object 30 is not supported by the support member 120, the control unit 100 causes the robot 1 to perform a motion in the downward direction from above the support object 30. Then, the control unit 100 causes the support member 120 to start support of the support object 30 by engaging the support member 120 with the recess of the support object by moving the robot 1 in the downward direction. When the support object is supported by the support member 120, the control unit 100 causes the robot 1 to perform a motion in the downward direction to put the support object 30 down. Then, the control unit 100 causes the support member 120 to finish the support of the support object 30 by releasing the engagement between the support member 120 and the recess of the support object 30. At this time, the control unit 100, for example, causes the mechanism included in the support member 120 to operate by the motion of the robot 1, thereby releasing the engagement between the support member 120 and the recess of the support object 30. Alternatively, the control unit 100 may move the support member 120 by driving the actuator included in the shaft 124 of the support member 120, thereby releasing the engagement between the support member 120 and the recess of the support object 30.

The control unit 100 performs a process for controlling the attitude of the robot 1. For example, the control unit 100 detects a positional relationship between the hollow portion 110 and the support object 30 on the basis of the support object information detected in the detection process and detects a difference between the attitude of the support object 30 and the attitude of the robot 1 on the basis of the positional relationship. Then, the control unit 100 corrects the attitude of the robot 1 according to the attitude of the support object 30 so that the robot 1 becomes an attitude that enables the robot 1 to easily insert the support object 30 into the hollow portion 110. Then, the control unit 100 causes the robot 1 with the corrected attitude to perform a motion in the downward direction.

An example of correction of the attitude of the robot 1 by the control unit 100 will be described with reference to FIG. 11. FIG. 11 is a diagram illustrating an example of the attitude control process of the robot 1 according to the embodiment of the present disclosure. The left figure in FIG. 11 illustrates the attitude of the robot 1 before correction. The right figure in FIG. 11 illustrates the attitude of the robot 1 after correction. For example, it is assumed that the support object 30 is tilted by a projection 40 with respect to the ground as illustrated in the left figure in FIG. 11. At this time, the robot 1 detects the tilt of the support object 30 on the basis of the support object information detected in the detection process. As illustrated in the right figure in FIG. 11, for example, the robot 1 corrects the attitude of the robot 1 by tilting the robot 1 according to the detected tilt so that the main body 10 of the robot 1 becomes horizontal to the upper face of the support object 30. Then, the robot 1 performs a motion in the downward direction while maintaining the corrected attitude.

### (2) Communication Unit 102

The communication unit 102 has a function of performing communication with an external device. For example, the communication unit 102 performs communication with a communication unit included in the support object 30 to transmit and receive information. Specifically, the communication unit 102 receives support object information through the communication with the communication unit of the support object 30. Then, the communication unit 102 outputs the received support object information to the control unit 100.

### (3) Sensor Unit 104

The sensor unit 104 has a function of acquiring support object information related to the support object 30. The sensor unit 104 can include various sensors to acquire the support object information. For example, the sensor unit 104 can include a camera, a thermographic camera, a depth sensor, a microphone, and an inertial sensor. Note that the sensor unit 104 may include one or more of these sensors in combination, or may include a plurality of sensors of the same type.

The camera is an imaging device such as an RGB camera that includes a lens system, a driving system, and an image sensor and captures an image (a still image or a moving image). The thermographic camera is an imaging device that captures an image including information indicating the temperature of an imaging subject by using, for example, infrared rays. The depth sensor is a device that acquires depth information, such as an infrared distance measuring device, an ultrasound distance measuring device, a Laser Imaging Detection and Ranging (LiDAR), or a stereo camera. The microphone is a device that collects sounds around the microphone and outputs sound data obtained by converting the collected sounds to a digital signal through an amplifier and an analog digital converter (ADC). The inertial sensor is a device that detects acceleration and angular velocity.

The camera, thermographic camera, and the depth sensor detect the distance between the robot 1 and the support object 30 and can be used in detection of the positional relationship between the robot 1 and the support object 30 based on the detected distance. The microphone detects a sound wave output from the support object 30 and can be used in detection of the support object 30 based on the detected sound wave. The inertial sensor can be used in detection of the attitude of the robot 1 and the attitude of the support object 30.

These sensors can be installed in various manners. For example, the sensors are attached to the main body 10 of the robot 1. Specifically, the sensors may be attached to any of the upper face, the lower face, the side faces, and the main body inner face of the main body 10. Moreover, the sensors may be attached to the leg 20. Specifically, the sensors may be attached to the joint member 200, the toe 202, the link 204, and the closed link mechanism 206 of the leg 20.

### (4) Storage Unit 106

The storage unit 106 has a function of storing data acquired in the processes in the control unit 100. For example, the storage unit 106 stores support object information received by the communication unit 102. The storage unit 106 may store data detected by the sensor unit 104. The storage unit 106 may store control information of the robot 1 output from the control unit 100. Note that information stored in the storage unit 106 is not limited to the above example. For example, the storage unit 106 may store programs of various applications and data.

### 1.4. Motion Example

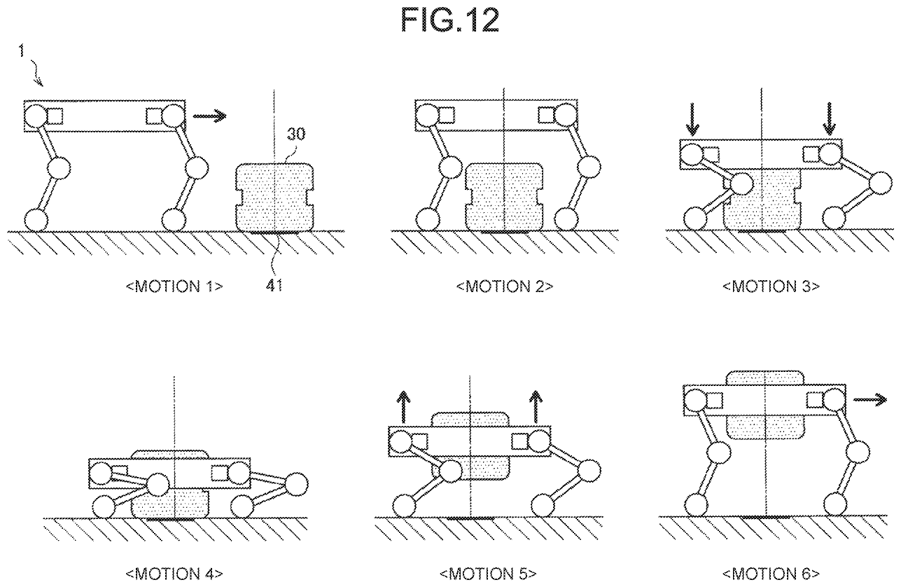

Hereinbelow, the flow of the motion of the robot 1 and the flow of the process of the control unit 100 according to the embodiment of the present disclosure will be described with reference to FIGS. 12 to 15.

### (1) Support Start Motion

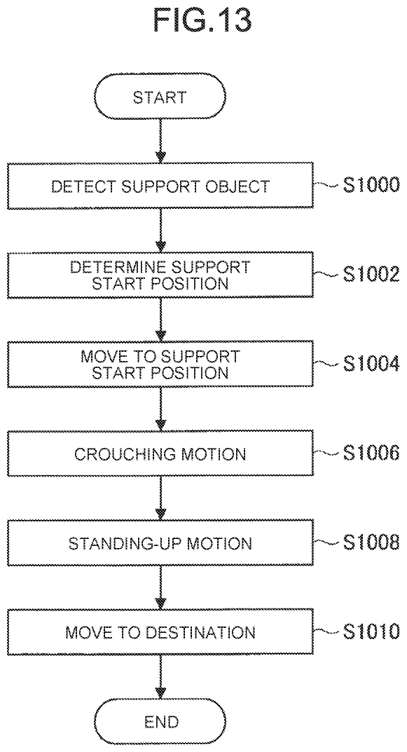

First, the flow of the motion of the robot 1 when the robot 1 starts support of the support object and carries the support object will be described with reference to FIGS. 12 and 13.

(Motion Example of Robot 1)

FIG. 12 is a diagram illustrating the flow of the support start motion of the robot 1 according to the embodiment of the present disclosure. When starting support of the support object 30, the robot 1 performs motions illustrated in FIG. 12 in the order from a motion 1 to a motion 6. First, the robot 1 determines a support start position 41 for the support object 30 by detecting the support object 30 and starts moving to the support start position 41 (motion 1). The robot 1 moves up to the support start position 41 (motion 2). After moving to the support start position 41, the robot 1 starts a crouching motion at the support start position 41 (motion 3). The robot 1 supports the support object 30 by the crouching motion (motion 4). After supporting the support object 30, the robot 1 starts a standing-up motion (motion 5). After standing up, the robot 1 carries the support object 30 to the destination (motion 6).

(Process Example of Control Unit 100)

FIG. 13 is a flowchart illustrating the flow of a support start motion process in the control unit 100 according to the embodiment of the present disclosure. As illustrated in FIG. 13, the control unit 100 first detects the support object 30 on the basis of sensing data detected by the sensor unit 104 (step S1000). The control unit 100 determines the support start position 41 for the support object 30 on the basis of a result of the detection of the support object 30 (step S1002). The control unit 100 moves the robot 1 to the support start position 41 by driving the legs 20 of the robot 1 (step S1004). At the support start position 41, the control unit 100 causes the robot 1 to perform the crouching motion by driving the legs 20 of the robot 1 to support the support object 30 (step S1006). After the robot 1 supports the support object 30, the control unit 100 causes the robot 1 to perform the standing-up motion by driving the legs 20 (step S1008). After completion of the standing-up motion, the control unit 100 causes the robot 1 to move to the destination while supporting the support object 30 (step S1010).

### (2) Support Finish Motion

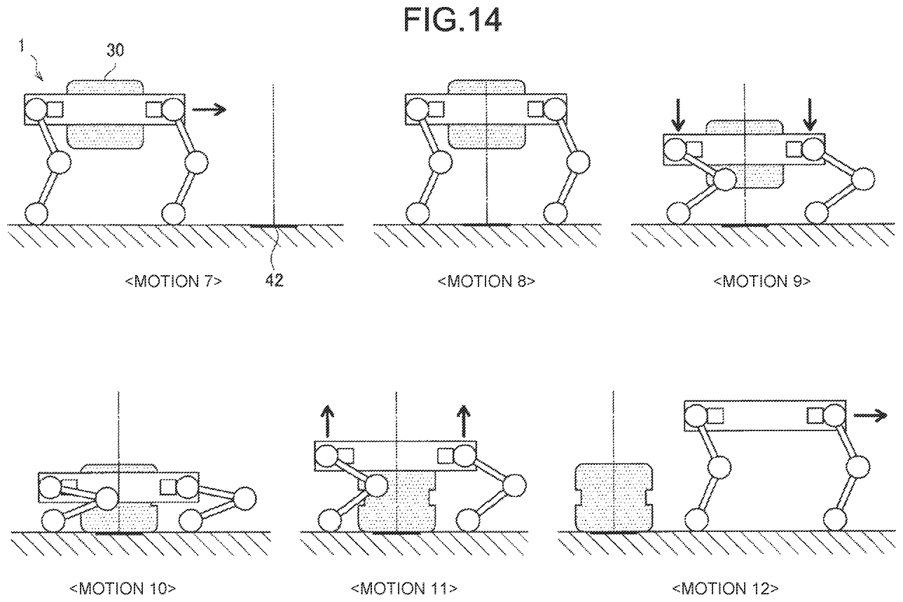

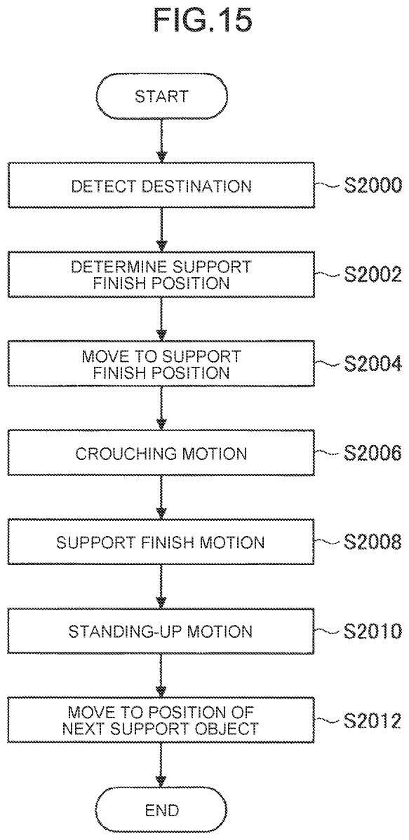

Next, the flow of the motion of the robot 1 when the robot 1 finishes the support of the support object and moves to the position of the next support object will be described with reference to FIGS. 14 and 15.

(Motion Example of Robot 1)

FIG. 14 is a diagram illustrating the flow of the support finish motion of the robot 1 according to the embodiment of the present disclosure. When finishing the support of the support object 30, the robot 1 performs motions illustrated in FIG. 14 in the order from a motion 7 to a motion 12. First, the robot 1 determines a support finish position 42 where the robot 1 puts the supported support object 30 down to finish the support by detecting a destination to be a carrying destination of the support object 30 and starts moving to the support finish position 42 (motion 7). The robot 1 moves up to the support finish position 42 (motion 8). After moving to the support finish position 42, the robot 1 starts a crouching motion at the support finish position 42 (motion 9). Upon completion of the crouching motion, the robot 1 releases the support object 30 to finish the support of the support object 30 (motion 10). After finishing the support of the support object 30, the robot 1 starts a standing-up motion (motion 11). After standing up, the robot 1 starts moving to the position of the support object 30 to be carried next (motion 12).

(Process Example of Control Unit 100)

FIG. 15 is a flowchart illustrating the flow of a support finish motion process in the control unit 100 according to the embodiment of the present disclosure. As illustrated in FIG. 15, the control unit 100 first detects a destination on the basis of sensing data detected by the sensor unit 104 (step S2000). The control unit 100 determines the support finish position 42 for the support object 30 on the basis of a result of the detection of the destination (step S2002). The control unit 100 moves the robot 1 to the support finish position 42 by driving the legs 20 of the robot 1 (step S2004). At the support finish position 42, the control unit 100 causes the robot 1 to perform the crouching motion by driving the legs 20 of the robot (step S2006). Upon completion of the crouching motion, the control unit 100 causes the robot 1 to finish the support of the support object 30 (step S2008). After the support mechanism finishes the support of the support object, the control unit 100 causes the robot 1 to perform the standing-up motion by driving the legs 20 of the robot 1 (step S2010). After completion of the standing-up motion, the control unit 100 moves the robot 1 to the position of the support object 30 to be carried next (step S2012).

### 2. Exemplary Embodiments

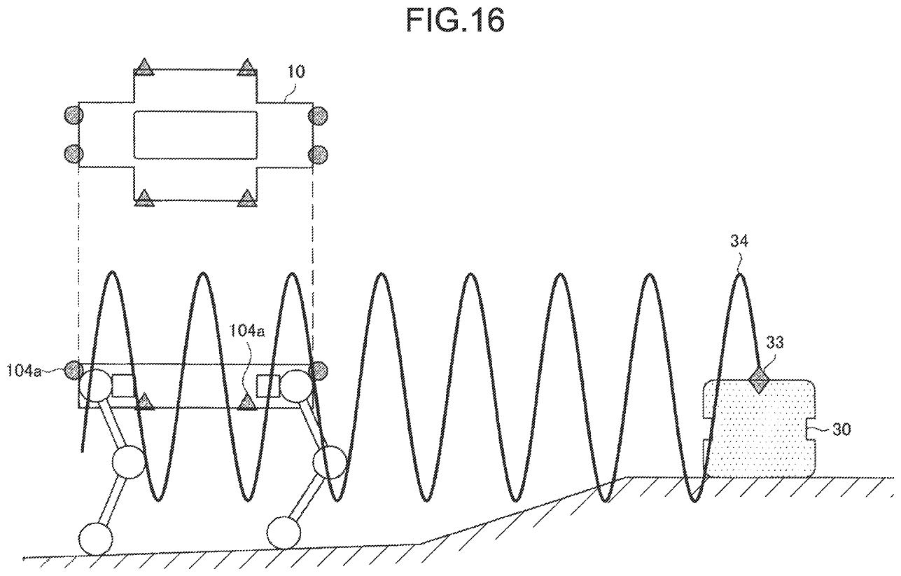

Hereinbelow, exemplary embodiments according to the embodiment of the present disclosure will be described with reference to FIGS. 16 to 21. Note that the exemplary embodiments described below may be applied to the embodiment of the present disclosure solely or in combination. Moreover, the exemplary embodiments may be applied instead of or in addition to the configuration described in the embodiment of the present disclosure.

### (1) First Exemplary Embodiment

Hereinbelow, a first exemplary embodiment according to the embodiment of the present disclosure will be described with reference to FIG. 16. FIG. 16 is a diagram illustrating an example of a method for detecting the support object 30 according to the embodiment of the present disclosure. The first exemplary embodiment describes a concrete example of the method for detecting the support object 30 by the robot 1. The robot 1, for example, detects the support object 30 by acquiring information output from the support object 30. Specifically, as illustrated in FIG. 16, an output device 33 included in the support object 30 outputs a sound wave 34 having a specific frequency that is known by the robot 1. The robot 1 includes a microphone 104a as the sensor unit 104 and acquires the sound wave 34 through the microphone 104a. Then, the robot 1 detects the support object 30 on the basis of the acquired sound wave 34. Then, the robot 1 detects the relative positional relationship between the robot 1 and the support object 30 on the basis of the position of the detected support object 30. Note that an installation position of the microphone 104a is not limited to any particular position, and the microphone 104a is attached to any position on the robot 1. For example, as illustrated in FIG. 16, the microphones 104a may be attached to positions indicated by circles on the upper face of the main body 10 or may be attached to positions indicated by triangles on the lower face of the main body 10.

### (2) Second Exemplary Embodiment

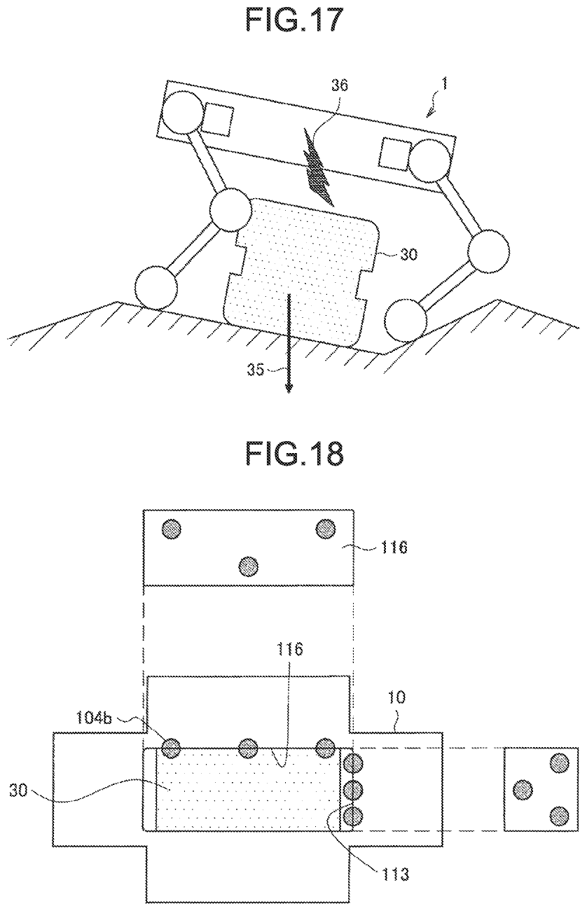

Hereinbelow, a second exemplary embodiment according to the embodiment of the present disclosure will be described with reference to FIG. 17. FIG. 17 is a diagram illustrating an example of an attitude control process using communication according to the embodiment of the present disclosure. The second exemplary embodiment describes a concrete example of a method for performing the attitude control process by the robot 1 on the basis of support object information acquired through communication. For example, the robot 1 receives support object information transmitted from the communication unit included in the support object 30 through the communication unit 102 and controls the attitude of the robot 1 on the basis of the received support object information. At this time, the robot 1, for example, corrects the attitude of the robot 1 with respect to the Roll axis and the Pitch axis. The support object 30 includes, for example, an acceleration sensor and detects tilt information of the support object 30 with respect to gravity 35 by using the acceleration sensor. Then, the support object 30 transmits support object information including the detected tilt information to the communication unit 102 of the robot 1 through wireless communication 36.

### (3) Third Exemplary Embodiment

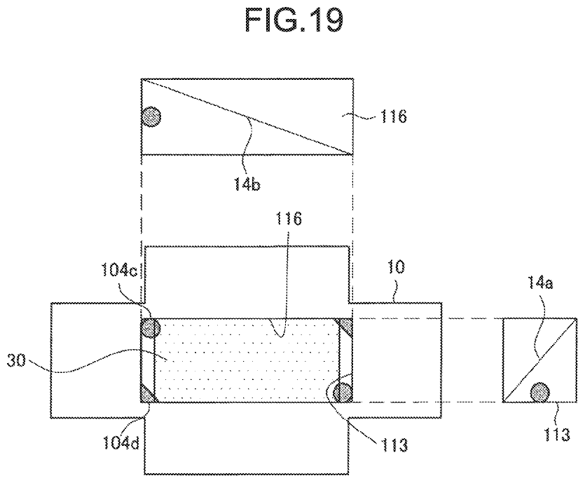

Hereinbelow, a third exemplary embodiment according to the embodiment of the present disclosure will be described with reference to FIGS. 18 and 19. The third exemplary embodiment describes a concrete example of a method for performing the attitude control process on the basis of information acquired by the sensor unit 104.

FIG. 18 is a diagram illustrating an example of an attitude control process using a distance measuring sensor according to the embodiment of the present disclosure. In the example illustrated in FIG. 18, the robot 1 performs the attitude control process on the basis of support object information acquired by a distance measuring sensor 104b. As illustrated in FIG. 18, the robot 1, for example, includes the distance measuring sensors 104b at positions indicated by circles on the hollow portion front face 113 and the hollow portion left side face 116 of the main body inner face. The robot 1 includes the distance measuring sensors 104b on at least two faces of the main body inner face to acquire attitude information on the two faces of the support object 30 inserted in the hollow portion 110. The attitude information includes, for example, an angle indicating a tilt of the support object 30. The robot 1 detects the relative distance and angle between the hollow portion 110 and the support object 30 on the basis of the acquired attitude information of the support object 30. Then, the robot 1 corrects the attitude of the robot 1 on the basis of the detected relative distance and angle so that the support object 30 is inserted in the hollow portion 110 in a fitted manner. At this time, the robot 1, for example, corrects the attitude of the robot 1 with respect to the Yaw axis.

Note that, on the main body inner face, the face to which the distance measuring sensor 104b is attached is not limited to any particular face. Moreover, on the main body inner face, the position to which the distance measuring sensor 104b is attached is not limited to any particular position. However, it is desired that the distance measuring sensors 104b be not linearly disposed on one face of the main body inner face. For example, as illustrated in FIG. 18, the distance measuring sensors 104b that are not linearly disposed facilitate detection of the faces of the support object 30.

FIG. 19 is a diagram illustrating an example of an attitude control process using a laser light source according to the embodiment of the present disclosure. In the example illustrated in FIG. 19, the robot 1 performs the attitude control process on the basis of support object information acquired by a camera 104c and a laser light source 104d. As illustrated in FIG. 19, the robot 1, for example, includes the cameras 104c at positions indicated by circles and the laser light sources 104d at positions indicated by triangles on the main body inner face. The robot 1 causes the laser light source 104d to output a linear laser beam 14 in a diagonal direction from the disposed position and causes the camera 104c to capture an image of reflected light of the laser beam 14 reflected by the support object 30. The robot 1 detects the relative position and attitude between the hollow portion 110 and the support object 30 on the basis of the image captured by the camera 104c. Then, the robot 1 corrects the attitude of the robot 1 on the basis of the detected relative position and attitude so that the support object 30 is inserted into the hollow portion 110 in a fitted manner. At this time, the robot 1, for example, corrects the attitude of the robot 1 with respect to the Yaw axis.

Note that, on the main body inner face, the face to which the camera 104c and the laser light source 104d are attached is not limited to any particular face. Moreover, on the main body inner face, positions to which the camera 104c and the laser light source 104d are attached are not limited to any particular positions. However, it is desired that the laser light source 104d outputs the laser beam 14 that is not parallel to any side on any face of the main body inner face. For example, the laser light source 104d outputs the laser beam 14 that is not parallel to any side on each face like a laser beam 14a applied to the hollow portion front face 113 and a laser beam 14b applied to the hollow portion left side face 116 as illustrated in FIG. 19. This facilitates detection of the faces of the support object 30.

### (4) Fourth Exemplary Embodiment

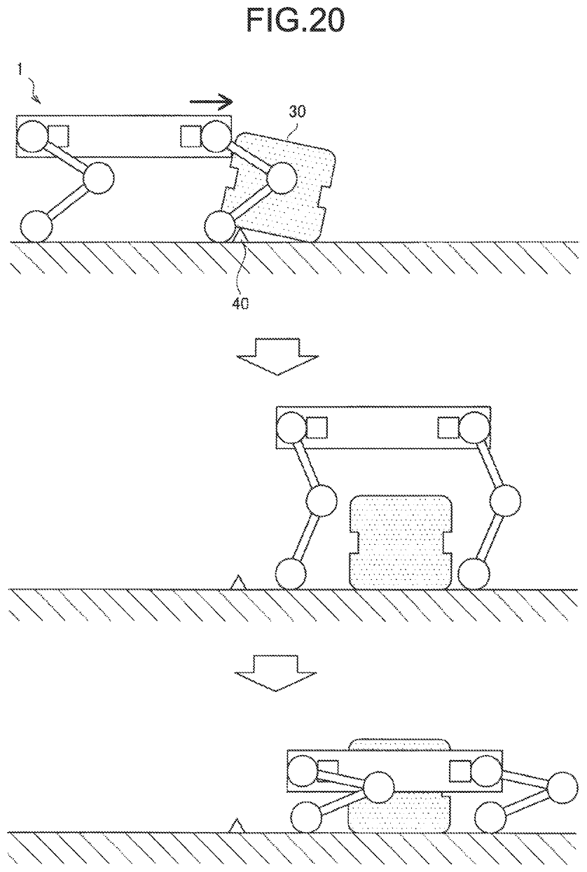

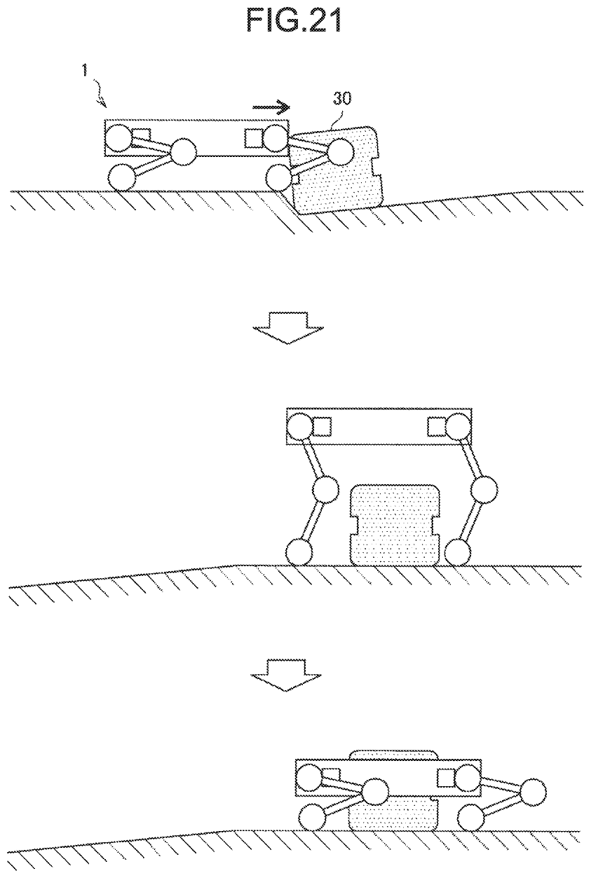

Hereinbelow, a fourth exemplary embodiment according to the embodiment of the present disclosure will be described with reference to FIGS. 20 and 21. The fourth exemplary embodiment describes an example in which, when the support object 30 is tilted, the robot 1 performs a supporting motion after correcting the attitude of the support object 30 by pushing and moving the support object 30 with the main body 10.

As an example of the condition where the support object 30 is tilted, a part of the support object 30 may run on an object. FIG. 20 is a diagram illustrating an example of correction of a tilt of the support object 30 caused by the projection 40 according to the embodiment of the present disclosure. As illustrated in FIG. 20, the support object 30 is tilted because a part of the support object 30 runs on the projection 40. At this time, as illustrated in the upper figure in FIG. 20, the robot 1 pushes the support object 30 with the main body 10. Then, as illustrated in the middle figure in FIG. 20, the robot 1 moves the support object 30 up to a position where the tilt of the support object 30 is eliminated. Then, as illustrated in the lower figure in FIG. 20, the robot 1 starts the supporting motion.

Moreover, as an example of the condition where the support object 30 is tilted, the support object 30 may get caught in a recess or the like. FIG. 21 is a diagram illustrating an example of correction of a tilt of the support object 30 caused by a recess according to the embodiment of the present disclosure. As illustrated in FIG. 21, the support object 30 is tilted because the support object 30 gets caught in the recess. At this time, as illustrated in the upper figure in FIG. 21, the robot 1 pushes the support object 30 with the main body 10. Then, as illustrated in the middle figure in FIG. 21, the robot 1 moves the support object 30 up to a position where the tilt of the support object 30 is eliminated. Then, as illustrated in the lower figure in FIG. 21, the robot 1 starts the supporting motion.

Note that, when detecting the support object 30, the robot 1 performs the motion of pushing the support object 30 with the main body 10 after determining whether or not the support object 30 is tilted. For example, the robot 1 determines whether or not the support object 30 is tilted on the basis of an image captured by the camera included in the sensor unit 104. Specifically, the robot 1 previously stores an image of the support object 30 in a horizontal state in, for example, the storage unit and compares the image captured by the camera with the stored image to determine whether or not the support object 30 is tilted. The robot 1 may determine whether or not the support object 30 is tilted on the basis of sensing information acquired by the acceleration sensor included in the support object 30. Moreover, when determining that the support object 30 is tilted, the robot 1 may put, for example, a bag or a net onto the support object 30 and pulls the bag or the net to move the support object 30.

### 3. Modification

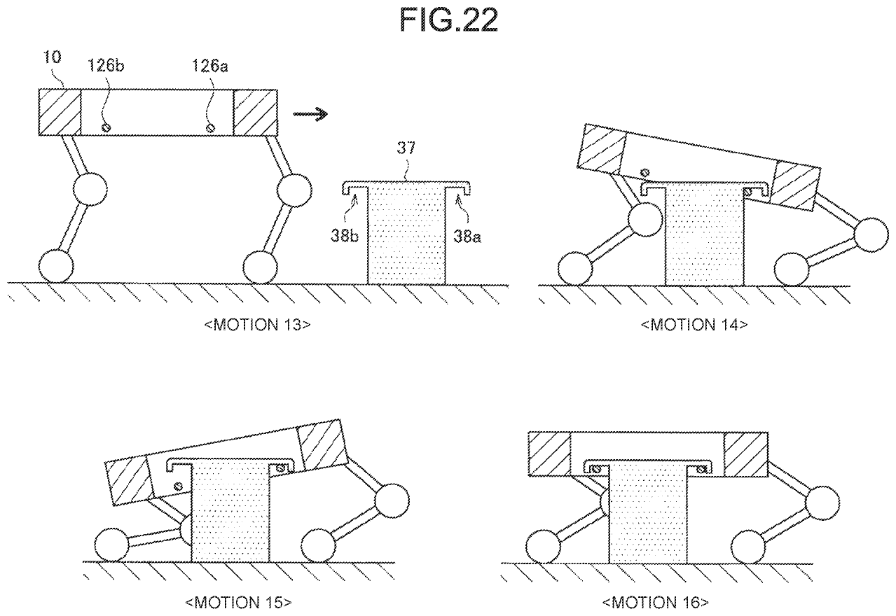

Hereinbelow, a modification of the embodiment of the present disclosure will be described with reference to FIG. 22. Note that the modification described below may be applied to the embodiment of the present disclosure solely or in combination. Moreover, the modification may be applied instead of or in addition to the configuration described in the embodiment of the present disclosure.

FIG. 22 is a diagram illustrating the modification of the embodiment of the present disclosure. The above embodiment describes an example in which the robot 1 includes the support member 120, the support object 30 includes the recess 31, and the robot 1 supports the support object 30 by performing motions in the upward direction and the downward direction. The present modification describes an example in which the robot 1 includes a projection 126, a support object 37 includes a grip 38, and the robot 1 supports the support object 37 by performing motions in the up-down direction and the front-rear direction.

As illustrated in FIG. 22, for example, the main body 10 of the robot 1 includes the projection 126. The support object 37 includes the grip 38. When starting support of the support object 37, the robot 1 performs motions illustrated in FIG. 22 in the order from a motion 13 to a motion 16. First, the robot 1 moves up to a position of the support object 37 (motion 13). Then, the robot 1 hooks a grip 38a on a projection 126a by moving the main body 10 through a combination of a movement in the up-down direction and a movement in the front-rear direction (motion 14). Then, the robot 1 moves a projection 126b to a position under a grip 38b by moving the main body 10 through a combination of a movement in the up-down direction and a movement in the front-rear direction (motion 15). Then, the robot 1 hooks the grip 38 on the projection 126b by moving the main body 10 in the upward direction (motion 16). The robot 1 can lift the support object 37 by further performing a motion in the upward direction after completion of the motion 16.

### 4. Hardware Configuration Example

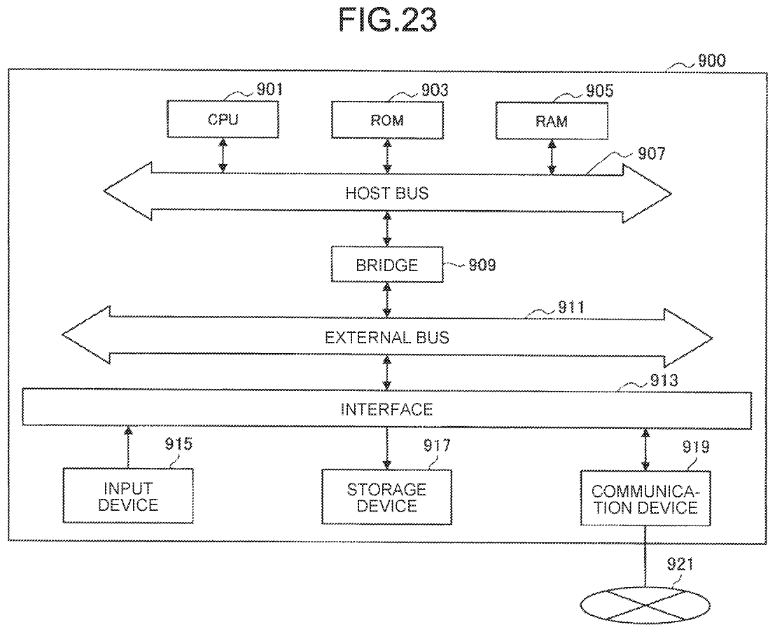

Hereinbelow, a hardware configuration example of a robot 900 according to an embodiment of the present disclosure will be described with reference to FIG. 23. FIG. 23 is a block diagram illustrating the hardware configuration example of the robot 900 according to the present embodiment. Information processing in the robot 900 according to the present embodiment is implemented through cooperation of software and hardware described below.

As illustrated in FIG. 23, the robot 900 includes a central processing unit (CPU) 901, a read only memory (ROM) 903, and a random access memory (RAM) 905. The robot 900 further includes a host bus 907, a bridge 909, an external bus 911, an interface 913, an input device 915, a storage device 917, and a communication device 919. Note that the hardware configuration described herein is an example, and some of the elements may be omitted. Moreover, the hardware configuration may further include an element other than the elements described herein.

(CPU 901, ROM 903, RAM 905)

The CPU 901 functions as, for example, an arithmetic processing device or a control device and entirely or partially controls operation of each element in accordance with various programs recorded in the ROM 903, the RAM 905, or the storage device 917. The ROM 903 is means for storing, for example, a program read into the CPU 901 and data used in an operation. For example, a program read into the CPU 901 and various parameters that appropriately vary when the program is executed are temporarily or permanently stored in the RAM 905. These are connected to each other through the host bus 907 which includes, for example, a CPU bus. The CPU 901, the ROM 903, and the RAM 905 can implement the functions of the control unit 100 described above with reference to FIG. 10, for example, through cooperation with software.

(Host Bus 907, Bridge 909, External Bus 911, Interface 913)

The CPU 901, the ROM 903, and the RAM 905 are connected to each other, for example, through the host bus 907 which is capable of performing high-speed data transmission. On the other hand, for example, the host bus 907 is connected to the external bus 911 having a relatively low data transmission speed through the bridge 909. The external bus 911 is connected to various elements through the interface 913.

(Input Device 915)

The input device 915 includes a device to which a user inputs information, such as a mouse, a keyboard, a touch panel, a button, a microphone, a switch, or a lever. Alternatively, the input device 915 may be, for example, a remote control device using infrared rays or other radio waves or an external connection device capable of operating the robot 900, such as a mobile phone or a PDA. Moreover, the input device 915 may include, for example, an input control circuit that generates an input signal on the basis of information input from a user using the above input means and outputs the input signal to the CPU 901. The user of the robot 900 can input various pieces of data or gives an instruction of processing motion to the robot 900 by operating the input device 915.

Alternatively, the input device 915 can include a device that detects information related to the user. For example, the input device 915 can include various sensors, such as an image sensor (e.g., a camera), a depth sensor (e.g., a stereo camera), an acceleration sensor, a gyro sensor, a geomagnetism sensor, an optical sensor, a sound sensor, a distance measuring sensor, and a force sensor. The input device 915 may acquire information related to the state of the robot 900 itself, such as the attitude or the moving speed of the robot 900, or information related to an environment around the robot 900, such as the brightness or noise around the robot 900. The input device 915 may include a Global Navigation Satellite System (GNSS) module that receives a GNSS signal from a GNSS satellite (e.g., a Global Positioning System (GPS) signal from a GPS satellite) to measure positional information including the latitude, the longitude, and the altitude of the device. For the positional information, the input device 915 may detect the position through Wi-Fi (registered trademark), transmission and reception with a mobile phone, a PHS, or a smartphone, or near field communication. For example, the input device 915 can implement the function of the sensor unit 104 described above with reference to FIG. 10.

(Storage Device 917)

The storage device 917 is a data storing device that is configured as an example of a storage unit of the robot 900. The storage device 917 includes, for example, a magnetic storage device, such as a HDD, a semiconductor storage device, an optical storage device, or a magneto-optical storage device. The storage device 917 may include, for example, a storage medium, a recording device that records data on the storage medium, a reading device that reads data from the storage medium, and a deletion device that deletes data recorded on the recording medium. The storage device 917 stores, for example, programs executed by the CPU 901 and various pieces of data therefor and various pieces of data acquired from outside. For example, the storage device 917 can implement the function of the storage unit 106 described above with reference to FIG. 10.

(Communication Device 919)

The communication device 919 is, for example, a communication interface such as a communication device for connection to a network 921. The communication device 919 is, for example, a wired or wireless local area network (LAN), Long Term Evolution (LTE), Bluetooth (registered trademark), or a communication card for Wireless USB (WUSB). The communication device 919 may be a router for optical communications, a router for asymmetric digital subscriber line (ADSL), or a modem for various communications. For example, the communication device 919 is capable of transmitting and receiving a signal or the like through the Internet or to and from another communication device in accordance with a predetermined protocol such as TCP/IP.

Note that the network 921 is a wired or wireless transmission line for information transmitted from a device connected to the network 921. For example, the network 921 may include a public network such as the Internet, a telephone network, or a satellite communication network, various local area networks (LANs) including Ethernet (registered trademark), or a wide area network (WAN). Moreover, the network 921 may include a leased line network such as an Internet Protocol-virtual private network (IP-VPN).

The hardware configuration example of the robot according to the present embodiment has been described above with reference to FIG. 23. Each of the elements described above may be implemented using a general-purpose member or through hardware specialized for the function of the element. Thus, the hardware configuration to be used can be appropriately changed according to the technical level at the time when the present embodiment is carried out.

### 5. Summary

As described above, the robot 1 according to the embodiment of the present disclosure includes the main body 10. The main body 10 includes the hollow portion 110, which is a hollow space penetrating the main body 10 in the up-down direction, and lifts and supports the support object 30 inserted in the hollow portion 110 by moving in the up-down direction. The robot 1 further includes the movable member. The movable member moves the main body 10 at least in the up-down direction by operating the legs 20. This enables the robot 1 to load and unload, and carry a load without an arm device installed outside the main body 10.

Thus, it is possible to provide a robot and a control method that are new and improved, and enable downsizing of a load carrying robot and reduction in an operation space.

The preferred embodiment of the present disclosure has been described in detail above with reference to the accompanying drawings. However, the technical scope of the present disclosure is not limited to the above examples. It is obvious that those skilled in the art of the present disclosure can conceive various modifications or corrections within the range of the technical idea described in claims, and it should be understood that these modifications and corrections also belong to the technical scope of the present disclosure as a matter of course.

Moreover, the process described in the present specification with reference to the flowchart may not necessarily be executed in the illustrated order. Some of the process steps may be executed in parallel. An additional process step may be employed, or some of the process steps may be omitted.

Furthermore, the effects described in the present specification are not limited effects, but solely explanatory or illustrative effects. In other words, the technique according to the present disclosure can achieve other effects that are obvious to those skilled in the art from the description of the specification, in addition to or instead of the above effects.

Note that the configurations as described below also belong to the technical scope of the present disclosure.

(1)

A robot comprising: a main body including a hollow portion that is a hollow space penetrating the main body in an up-down direction, the main body being configured to lift and support a support object inserted in the hollow portion by moving in the up-down direction; and a movable member configured to move the main body at least in the up-down direction by operating a leg.

(2)

The robot according to (1), wherein the main body inserts the support object into the hollow portion by moving at least in a downward direction when the main body is located above the support object.

(3)

The robot according to (1) or (2), wherein

the main body includes a support member configured to support the support object, and

the support member supports the support object when the support object is inserted in the hollow portion.

(4)

The robot according to (3), wherein the support member includes a movable claw and supports the support object by engaging the claw with the support object.

(5)

The robot according to (3) or (4), wherein the main body lifts and supports the support object by moving at least in an upward direction when the support object is supported by the support member.

(6)

The robot according to any one of (1) to (5), wherein

the hollow portion has a wedge shape, and

a difference between an area of a first opening and an area of a second opening in the hollow portion forms the wedge shape.

(4)

The robot according to any one of (1) to (6), wherein a center of gravity of the hollow portion is located within a predetermined range from a position of a center of gravity of the main body.

(4)

The robot according to any one of (1) to (7), wherein the leg includes a plurality of links and a plurality of movable members and performs a bending and stretching motion by operating the movable members to move the main body at least in the up-down direction.

(9)

The robot according to (8), wherein the leg includes a wheel on a tip of the leg.

(10)

The robot according to any one of (1) to (9), wherein the robot carries the support object by operating and moving the leg with the support object lifted and supported by the main body.

(11)

A control method executed by a processor, the method comprising:

controlling at least motions in an upward direction and a downward direction of a control object including a hollow portion that is a hollow space on a basis of support object information related to a support object; and

controlling a supporting motion of the control object with respect to the support object inserted in the hollow portion.

(12)

The control method according to (11), wherein the processor detects a position of the support object on the basis of the support object information and determines the detected position of the support object to be an execution position of motions in the upward direction and the downward direction.

(13)

The control method according to (12), wherein the processor moves the control object to the execution position and causes the control object to perform motions in the upward direction and the downward direction.

(14)

The control method according to any one of (11) to (13), wherein the processor detects a positional relationship between the hollow portion and the support object on the basis of the support object information and detects a difference between an attitude of the support object and an attitude of the control object on the basis of the positional relationship.

(15)

The control method according to (14), wherein the processor causes the control object to perform a motion in the downward direction after correcting the attitude of the control object according to the attitude of the support object on the basis of the difference.

(16)

The control method according to any one of (11) to (15), wherein the processor causes a support member included in the control object to start or finish support of the support object when the control object performs a motion in the downward direction.

(17)

The control method according to (16), wherein, when the support object is not supported by the support member, the processor causes the support member to start support of the support object by causing the control object to perform a motion in the downward direction from above the support object.

(18)

The control method according to (16) or (17), wherein, when the support object is supported by the support member, the processor causes the support member to finish support of the support object by causing the control object to perform a motion in the downward direction.

(19)

The control method according to any one of (11) to (18), wherein the processor causes a sensor unit included in the control object to sense the support object to acquire the support object information.

(20)

The control method according to any one of (11) to (19), wherein the processor causes a communication unit included in the control object to perform communication with a communication unit of the support object to acquire the support object information.

### REFERENCE SIGNS LIST

1 ROBOT
10 MAIN BODY
20 LEG
30 SUPPORT OBJECT
100 CONTROL UNIT
102 COMMUNICATION UNIT
104 SENSOR UNIT
106 STORAGE UNIT
110 HOLLOW PORTION
120 SUPPORT MEMBER
200 JOINT MEMBER

1. A robot comprising:
a main body including a hollow portion that is a hollow space penetrating the main body in an up-down direction, the main body being configured to lift and support a support object inserted in the hollow portion by moving in the up-down direction; and
a movable member configured to move the main body at least in the up-down direction by operating a leg.

2. The robot according to claim 1, wherein the main body inserts the support object into the hollow portion by moving at least in a downward direction when the main body is located above the support object.

3. The robot according to claim 1, wherein
the main body includes a support member configured to support the support object, and
the support member supports the support object when the support object is inserted in the hollow portion.

4. The robot according to claim 3, wherein the support member includes a movable claw and supports the support object by engaging the claw with the support object.

5. The robot according to claim 3, wherein the main body lifts and supports the support object by moving at least in an upward direction when the support object is supported by the support member.

6. The robot according to claim 1, wherein
the hollow portion has a wedge shape, and
a difference between an area of a first opening and an area of a second opening in the hollow portion forms the wedge shape.

7. The robot according to claim 1, wherein a center of gravity of the hollow portion is located within a predetermined range from a position of a center of gravity of the main body.

8. The robot according to claim 1, wherein the leg includes a plurality of links and a plurality of movable members and performs a bending and stretching motion by operating the movable members to move the main body at least in the up-down direction.

9. The robot according to claim 8, wherein the leg includes a wheel on a tip of the leg.

10. The robot according to claim 1, wherein the robot carries the support object by operating and moving the leg with the support object lifted and supported by the main body.

11. A control method executed by a processor, the method comprising:
controlling at least motions in an upward direction and a downward direction of a control object including a hollow portion that is a hollow space on a basis of support object information related to a support object; and
controlling a supporting motion of the control object with respect to the support object inserted in the hollow portion.

12. The control method according to claim 11, wherein the processor detects a position of the support object on the basis of the support object information and determines the detected position of the support object to be an execution position of motions in the upward direction and the downward direction.

13. The control method according to claim 12, wherein the processor moves the control object to the execution position and causes the control object to perform motions in the upward direction and the downward direction.

14. The control method according to claim 11, wherein the processor detects a positional relationship between the hollow portion and the support object on the basis of the support object information and detects a difference between an attitude of the support object and an attitude of the control object on the basis of the positional relationship.

15. The control method according to claim 14, wherein the processor causes the control object to perform a motion in the downward direction after correcting the attitude of the control object according to the attitude of the support object on the basis of the difference.

16. The control method according to claim 11, wherein the processor causes a support member included in the control object to start or finish support of the support object when the control object performs a motion in the downward direction.

17. The control method according to claim 16, wherein, when the support object is not supported by the support member, the processor causes the support member to start support of the support object by causing the control object to perform a motion in the downward direction from above the support object.

18. The control method according to claim 16, wherein, when the support object is supported by the support member, the processor causes the support member to finish support of the support object by causing the control object to perform a motion in the downward direction.

19. The control method according to claim 11, wherein the processor causes a sensor unit included in the control object to sense the support object to acquire the support object information.

20. The control method according to claim 11, wherein the processor causes a communication unit included in the control object to perform communication with a communication unit of the support object to acquire the support object information.
